(19) United States
(12) Patent Application Publication
(10) Pub. No.: US 2010/0153669 A1
(43) Pub. Date: Jun. 17, 2010

(54) STORAGE DEVICE AND STORAGE DEVICE CONTROL METHOD

(75) Inventors: Osamu YOSHIDA, Kawasaki-shi (JP); Shigenori YANAGI, Kawasaki-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/637,674

(22) Filed: Dec. 14, 2009

(30) Foreign Application Priority Data
Dec. 17, 2008 (JP) 2008-321558

(51) Int. Cl. G06F 12/16

(52) U.S. Cl. 711/162; 711/E12.103

(57) ABSTRACT

According to one embodiment, a storage device includes a storage medium and a controller. The storage medium includes a plurality of normal sectors that stores data and a redundant sector that stores redundant sector data for restoring data stored in each of the normal sectors. The controller stores invalid information in a normal sector when data is to be written to the normal sector belonging to a data section formed of a combination of the normal sectors and the redundant sector corresponding to the normal sectors. The invalid information indicates that the redundant sector data stored in the redundant sector belonging to the data section is invalid.

### CROSS-REFERENCE TO RELATED APPLICATIONS

This application is based upon and claims the benefit of priority from Japanese Patent Application No. 2008-321558, filed Dec. 17, 2008, the entire contents of which are incorporated herein by reference.

### BACKGROUND

1. Field

One embodiment of the invention relates to a storage device and a storage device control method.

2. Description of the Related Art

In recent years, the storage capacity of a storage device such as a magnetic disc device tends to be increased. For example, among recent magnetic disc devices has are those having the storage capacity of 1 terabyte (TB) or more. Generally, such a storage device improves recording density of a storage medium to increase the capacity. That is, a high-capacity storage device records a large amount of data on sectors as data read/write units.

If such a high-capacity storage device is used, when a data reading error occurs, a large amount of data are damaged. More specially, as described above, since the high-capacity storage device writes a large amount of data to one sector, when a reading error occurs in one sector, a large amount of data cannot be read. In particular, when a reading error occurs in a sector on which directory information for managing data is recorded, the storage device cannot read a larger amount of data.

In view of this, there have been recently proposed storage devices capable of restoring data with a reading error (see Japanese Patent Application Publication (KOKAI) No. 2008-77458, Japanese Patent Application Publication (KOKAI) No. 05-19979, Japanese Patent Application Publication (KOKAI) No. 05-35416, and Japanese Patent Application Publication (KOKAI) No. 07-44326). For example, Japanese Patent Application Publication (KOKAI) No. 2008-77458 discloses a conventional magnetic disc device in which, for each of a plurality of sectors, a calculation result of an exclusively logical sum of data stored in sectors is stored in a predetermined sector (hereinafter, “redundant sector”). The magnetic disc device restores data with a reading error by using data stored in the redundant sector when data cannot be read from a predetermined sector.

Hereinafter, data for error correction stored in the redundant sector is referred to as “redundant sector data”. A sector in which, for example, user data is stored other than the redundant sector is referred to as “normal sector”, and data stored in the normal sector is referred to as “normal sector data”. A combination of a plurality of normal sectors and a redundant sector that stores redundant sector data generated based on normal sector data stored in the normal sectors is referred to as data section“.

The conventional magnetic disc device stores information indicating whether the redundant sector data is valid in a predetermined memory. Specifically, the conventional magnetic disc device does not update redundant sector data when part of normal sector data belonging to a predetermined data section is updated. This is because if redundant sector data is updated each time part of normal sector data is updated, the processing performance degrades.

If redundant sector data is not updated despite the update of normal sector data, the magnetic disc device cannot restore data using the redundant sector data. To cope with this, the conventional magnetic disc device stores valid/invalid information indicating whether the normal sector data can be restored using the redundant sector data in a memory in association with each redundant sector.

Accordingly, the conventional magnetic disc device uses a large amount of memory resources. In particular, in recent magnetic disc devices, redundant sectors increase as the recording density of the storage medium increases, a large amount of memory resources are required to store the valid/invalid information.

For example, in the case of a magnetic disc device with a capacity of one TB, there are about 1 million tracks on the recording medium. Therefore, if a redundant sector is provided for each track, one million pieces of valid/invalid information is necessary, and thus a large amount of memory resources are used.

The magnetic disc device that stores valid/invalid information can restore data without degradation of the processing performance but uses a large amount of memory resources.

This is applied not only to the magnetic disc device but also to other storage devices such as magneto-optic disc devices, optical disc devices, and memory disc devices.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIGS. 1A and 1B are exemplary views for explaining a concept of a magnetic disc device according to an embodiment of the invention;

FIG. 2 is an exemplary view illustrating a relationship between the magnetic disc device and an upper apparatus in the embodiment;

FIG. 3 is an exemplary block diagram of the magnetic disc device in the embodiment;

FIG. 4 is an exemplary view illustrating sectors on a magnetic storage medium in the embodiment;

FIG. 5 is an exemplary view illustrating a structure of a normal sector of the magnetic storage medium in the embodiment;

FIG. 6 is an exemplary view illustrating a configuration of a redundancy generator in the embodiment;

FIG. 7 is an exemplary flowchart of a data write process performed by the magnetic disc device in the embodiment; and

FIG. 8 is an exemplary flowchart of a redundant sector data update process performed by the magnetic disc device in the embodiment.

### DETAILED DESCRIPTION

Various embodiments according to the invention will be described hereinafter with reference to the accompanying drawings. In general, according to one embodiment of the invention, a storage device comprises a storage medium and a controller. The storage medium comprises a plurality of normal sectors configured to store data and a redundant sector configured to store redundant sector data for restoring data stored in each of the normal sectors. The controller is configured to store invalid information in a normal sector when data is to be written to the normal sector belonging to a data section formed of a combination of the normal sectors and the redundant sector corresponding to the normal sectors. The invalid information indicates that the redundant sector data stored in the redundant sector belonging to the data section is invalid.

According to another embodiment of the invention, there is provided a storage device control method of controlling a storage device configured to access a storage medium comprising a plurality of normal sectors configured to store data and a redundant sector configured to store redundant sector data for restoring data stored in each of the normal sectors. The storage device control method comprises controlling the storage device to store invalid information in a normal sector when data is to be written to the normal sector belonging to a data section formed of a combination of the normal sectors and the redundant sector corresponding to the normal sectors. The invalid information indicates that the redundant sector data stored in the redundant sector belonging to the data section is invalid.

In the following, a storage device of an embodiment of the invention will be described by way of example as a magnetic disc device. However, the storage device is not limited to a magnetic disc device and may be, for example, a magneto-optic disc device, an optical disc device, and a memory disc device.

First, a concept of a magnetic disc device 100 according to an embodiment of the invention will be described. The magnetic disc device 100 of the embodiment is provided with a magnetic storage medium having a redundant sector which stores data for restoring normal sector data for each of a plurality of normal sectors. The magnetic disc device 100 stores information indicating whether the redundant sector data is valid in each normal sector. Hereinafter, information indicating whether redundant sector data is valid is referred to as “identification code”, and an area in which the identification code is stored is referred to as “identification area”.

Specifically, the magnetic disc device 100 stores identification data indicating that the redundant sector data is invalid in the identification area of the normal sector when updating the normal sector data without updating the redundant sector data with respect to a predetermined data section. Such an update may be performed when some normal sector data belonging to a predetermined data section is updated. This is because, as described above, if the redundant sector data is updated whenever some normal sector data belonging to the data section is updated, the processing performance of the magnetic disc device 100 degrades.

The magnetic disc device 100 stores identification data indicating that the redundant sector data is valid in the identification area of the normal sector when updating the redundant sector data and the normal sector data with respect to a predetermined data section. Such an update may be performed when all the normal sector data belonging to a predetermined data section is updated.

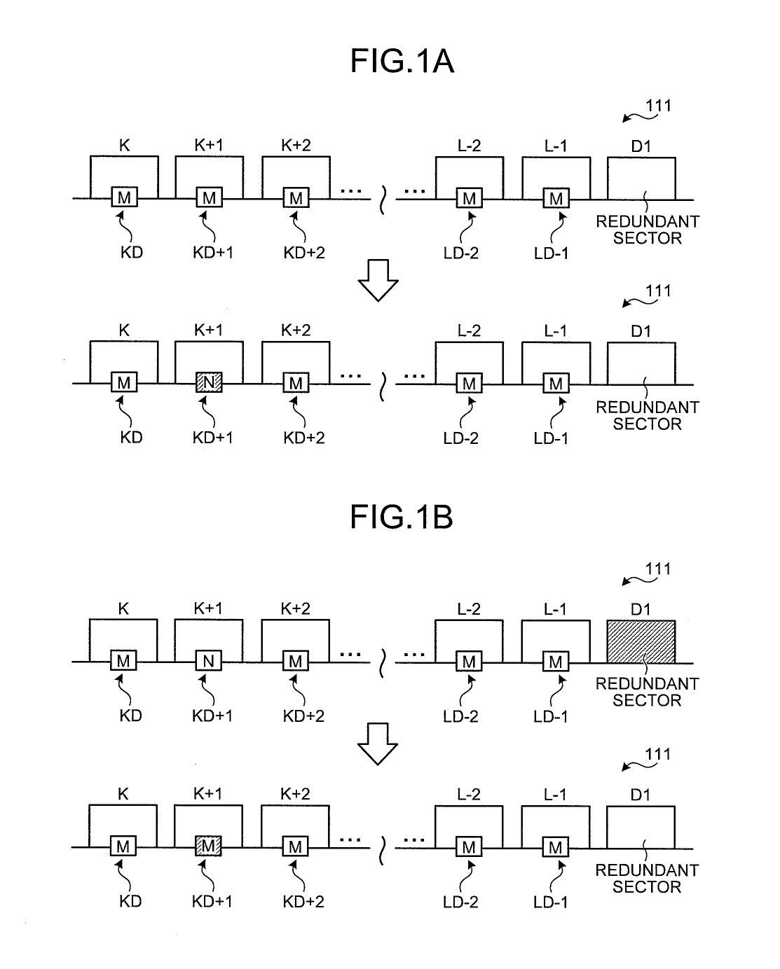

A concept of the magnetic disc device 100 will be described in detail with reference to FIGS. 1A and 1B. FIGS. 1A and 1B are views for explaining a concept of the magnetic disc device 100 of the embodiment.

FIGS. 1A and 1B illustrate one data section on a magnetic storage medium 111 in the magnetic disc device 100 of the embodiment. In FIG. 1A, rectangles denoted by K to L−1 represent normal sectors, and a rectangle denoted by D1 represents a redundant sector. K to L−1 and D1 denote logical block addresses (LBAs) conferred in units for accessing the magnetic storage medium 111.

As illustrated in FIG. 1A, the magnetic storage medium 111 has identification areas KD to LD−1 in normal sectors K to L−1, respectively. The magnetic disc device 100 stores identification codes indicating whether the redundant sector data stored in the redundant sector D1 is valid in the identification areas KD to LD−1. In this specification, an identification code M indicates that the redundant sector data is valid, while an identification code N indicates that the redundant sector data is invalid.

The magnetic disc device 100 can determine whether the redundant sector data is valid by using the identification codes stored in the identification areas KD to LD−1. For example, in a state illustrated in an upper portion of FIG. 1A, it is assumed that the magnetic disc device 100 cannot read data from the normal sector K+2. In this case, since all the identification codes stored in the identification areas KD to LD−1 of the normal sectors K to L−1 are M, the magnetic disc device 100 can determine that the redundant sector data stored in the redundant sector D1 is valid. Therefore, the magnetic disc device 100 may calculate an exclusive logical sum of the normal sector data stored in the normal sectors K, K+1, and K+3 to L−1 and the redundant sector data stored in the redundant sector D1 to restore data stored in the normal sector K+2.

In the state illustrated in the upper portion of FIG. 1A, it is assumed that the magnetic disc device 100 updates the normal sector data stored in the normal sector K+1 without updating the redundant sector data. In this case, the magnetic disc device 100 stores the identification code N indicating that the redundant sector data stored in the redundant sector D1 is invalid in the identification area KD+1 of the normal sector K+1 as illustrated by oblique lines in a lower portion of FIG. 1A.

In the state illustrated in the lower portion of FIG. 1A, it is assumed that the magnetic disc device 100 cannot read data from the normal sector K+2. In this case, since N is included in the identification codes stored in the identification areas KD to LD−1 of the normal sectors K to L−1, the magnetic disc device 100 can determine that the redundant sector data is invalid. In such a case, the magnetic disc device 100 does not calculate the exclusive logical sum as described above but notifies an upper apparatus of the fact that a reading error occurs.

As described above, the magnetic disc device 100 stores information indicating whether the redundant sector data is valid in the normal sector and thus can determine the validity of the redundant sector data without using the memory resource.

Next, the process of updating the redundant sector data through the magnetic disc device 100 will be described. The magnetic disc device 100 updates the redundant sector data at predetermined timing. The “predetermined timing” may be, for example, timing in which access to the magnetic storage medium 111 is not performed.

Specifically, the magnetic disc device 100 reads the normal sector data of each data section from the magnetic storage medium 111 at predetermined timing. The magnetic disc device 100 determines whether the identification code indicating that the redundant sector data is invalid is stored in the identification area of the read normal sector data. Therefore, when it is determined that the identification code indicating that the redundant sector data is invalid is stored in the identification area, the magnetic disc device 100 generates redundant sector data by using the read normal sector data and stores the generated redundant sector data in the redundant sector.

Such an update of the redundant sector data will be described in detail with reference to FIG. 1B. An upper portion of FIG. 1B illustrates the data section of the similar state to the state illustrated in the lower portion of FIG. 1A. That is, in the data section illustrated in the upper portion of FIG. 1B, the identification code N is stored in the identification area KD+1 of the normal sector K+1.

In this state, the magnetic disc device 100 reads the normal sector data from the normal sector K to L−1 at predetermined timing. The magnetic disc device 100 generates redundant sector data by using the read normal sector data since the identification code N is stored in the identification area KD+1. The magnetic disc device 100 updates the redundant sector data stored in the redundant sector D1 with the generated redundant sector data as illustrated by oblique lines in the upper portion of FIG. 1B.

Next, the magnetic disc device 100 updates the identification code stored in the identification area KD+1 from N to M as illustrated by oblique lines in the lower portion of FIG. 1B. Therefore, the magnetic disc device 100 can determine that the redundant sector data stored in the redundant sector D1 is valid.

Generally, the upper apparatus such as a personal computer (PC) shortly accesses the magnetic disc device 100 during its operation. That is, the magnetic disc device 100 spends most of time in a state of waiting a command from the upper apparatus. Therefore, as illustrated in the lower portion of FIG. 1A, even when the redundant sector data is invalid, the magnetic disc device 100 can immediately make the redundant sector data become a valid state.

As described above, the magnetic disc device 100 of the embodiment stores the identification code indicating whether the redundant sector data is valid in the normal sector on the magnetic storage medium 111. Therefore, the magnetic disc device 100 can determine the validity of the redundant sector data without using the memory resource and restore the normal sector data. As a result, the magnetic disc device 100 can improve reliability of the magnetic disc.

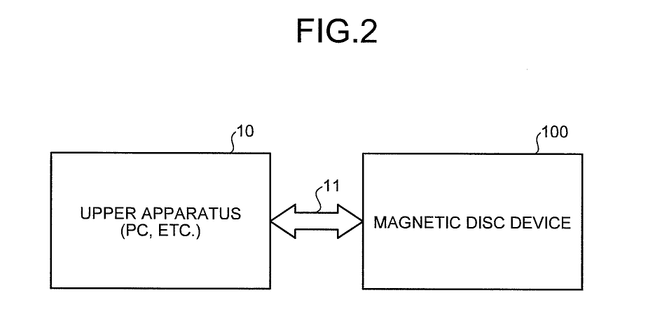

Next, a relationship between the magnetic disc device 100 and an upper apparatus of the embodiment will be described. FIG. 2 illustrates a relationship between the magnetic disc device 100 and an upper apparatus 10 according to the embodiment. As illustrated in FIG. 2, the magnetic disc device 100 is connected with the upper apparatus 10 such as the personal computer (PC) through a host interface (I/F) 11.

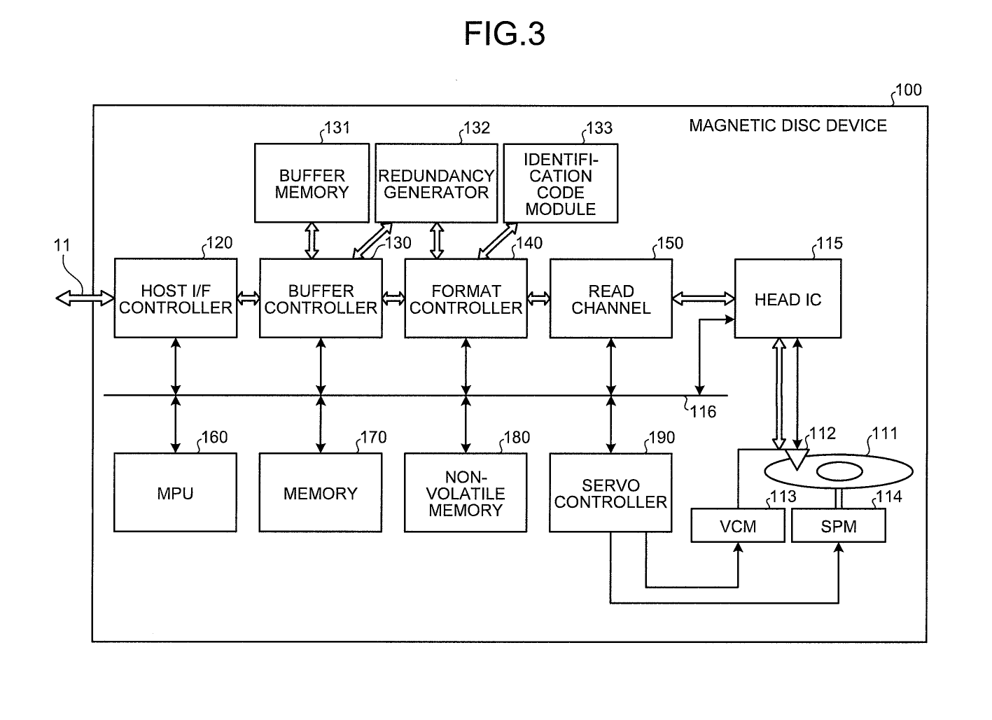

Next, a configuration of the magnetic disc device 100 of the embodiment will be described. FIG. 3 illustrates a configuration of the magnetic disc device 100 of the embodiment. As illustrated in FIG. 3, the magnetic disc device 100 comprises the host I/F 11, the magnetic storage medium 111, a head 112, a voice coil motor (VCM) 113, a spindle motor (SPM) 114, a head integrated circuit (IC) 115, a common bus 116, a host I/F controller 120, a buffer controller 130, a buffer memory 131, a redundancy generator 132, a identification code module 133, a format controller 140, a read channel 150, a micro processing unit (MPU) 160, a memory 170, a non-volatile memory 180, and a servo controller 190.

The host I/F 11 is an interface for connecting the magnetic disc device 100 with the upper apparatus 10 as illustrated in FIG. 2. The magnetic storage medium 111 is configured such that a magnetic film is formed on a disc-like substrate made of metal or glass and stores data. As described above, the magnetic storage medium 111 of the embodiment has a redundant sector for a plurality of normal sectors.

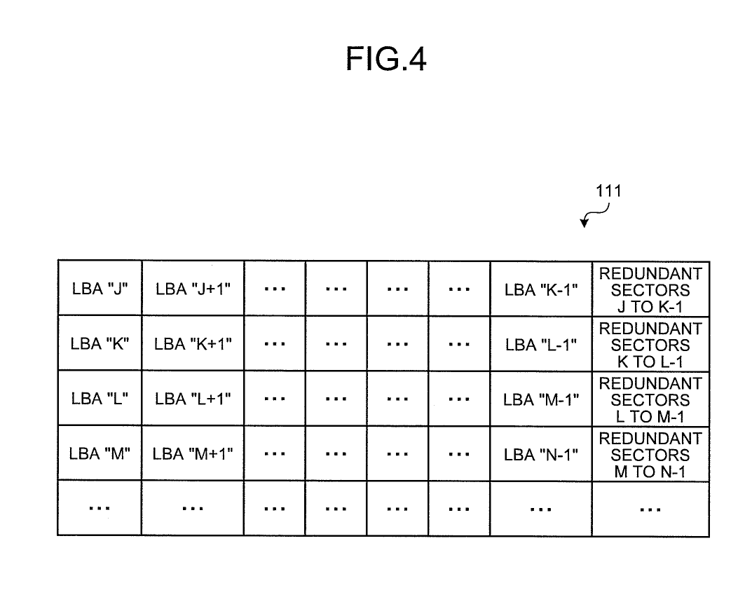

FIG. 4 illustrates an example of sectors on the magnetic storage medium 111 of the embodiment. In FIG. 4, each row represents one data section. For example, the first row of FIG. 4 represents a data section configured by a combination between normal sectors J to K−1 and a redundant sector of the normal sectors J to K−1. Further, for example, the second row of FIG. 4 represents a data section configured by a combination between normal sectors K to L−1 and a redundant sector of the normal sectors K to L−1.

The magnetic storage medium 111 has the respective data sections illustrated in FIG. 4 on the same track or different tracks. For example, the magnetic storage medium 111 has the data sections of the first to fourth rows illustrated in FIG. 4 on the same track. For example, the magnetic storage medium 111 has the respective data sections illustrated in FIG. 4 on different tracks, or has the data sections of the first and second rows illustrated in FIG. 4 on a predetermined track A and the data sections of the third and fourth rows illustrated in FIG. 4 on a predetermined track B. For example, the magnetic storage medium 111 has one data section on one track.

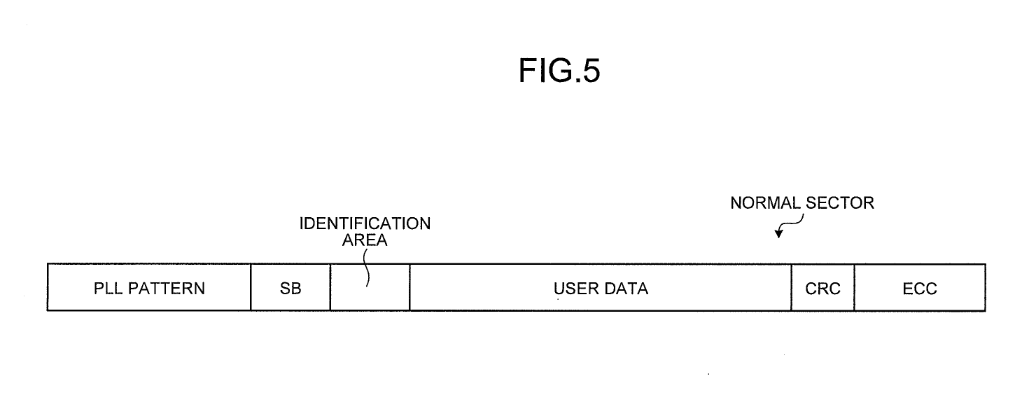

Further, the magnetic storage medium 111 has an identification area in each normal sector. FIG. 5 illustrates an example of structure of the normal sector of the magnetic storage medium 111 of the embodiment. As illustrated in FIG. 5, the normal sector of the magnetic storage medium 111 is divided into areas such as a phase locked loop (PLL) pattern, a sync byte (SB), an identification area, user data, a cyclic redundancy check (CRC), and an error correcting code (ECC).

The PLL pattern is an area in which a signal for synchronizing a clock signal of the magnetic disc device 100 is read. The SB is an area in which a signal indicating a start of the user data is read. The identification area is an area in which the identification code is stored. The size of the identification area is, for example, 1 byte. The user data is an area in which the user data is stored. The CRC is an area in which data for verifying consistency of data is stored. The ECC is an area in which ECC information for correcting an error comprised in the normal sector data is stored.

As described above, according to the embodiment, the magnetic storage medium 111 has the identification area in the normal sector. Therefore, the magnetic disc device 100 can determine whether the redundant sector data of the data section to which the normal sector belongs is valid based on the identification data stored in the identification area.

The structure of the normal sector illustrated in FIG. 5 is one example, and the areas need not necessarily be arranged in the normal sector in the order illustrated in FIG. 5. For example, the identification area may be set in the first position of the normal sector or in the last position of the normal sector.

Referring back to FIG. 3, the head 112 maintains a state slightly floated from a surface of the magnetic storage medium 111 by lift force generated by rotation of the magnetic storage medium 111 and performs data reading and writing. The head 112 illustrated in FIG. 3 comprises a read head for reading data and a write head for writing data.

The VCM 113 is a head driving mechanism driven by the servo controller 190 and rotates an arm above the magnetic storage medium 111. The SPM 114 is a mechanism driven by the servo controller 190 and rotates the magnetic storage medium 111.

The head IC 115 comprises a pre-amplifier (not illustrated) and pre-amplifies a data signal read by the head 112 at the time of data reading. The common bus 116 connects respective processors in the magnetic disc device 100 and performs transmission of various information between the processors.

The host I/F controller 120 is connected to the upper apparatus 10 through the host I/F 11 and controls communication with the upper apparatus 10. The buffer controller 130 controls the buffer memory 131. The buffer memory 131 temporarily stores information exchanged between the upper apparatus 10 and the magnetic disc device 100.

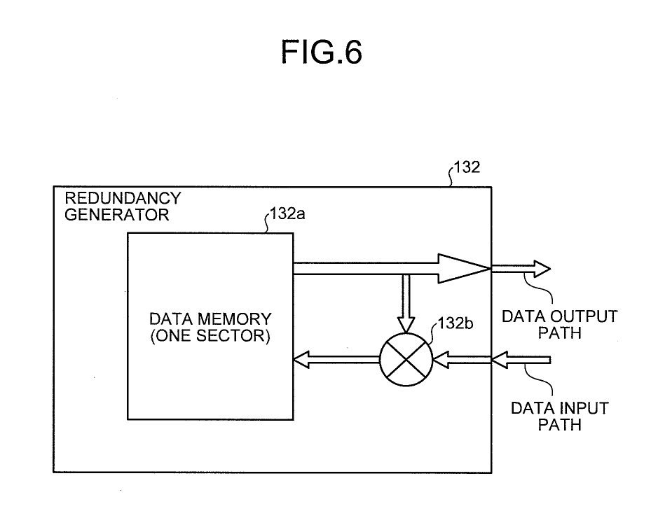

The redundancy generator 132 generates redundant sector data. FIG. 6 illustrates an example of configuration of the redundancy generator 132. As illustrated in FIG. 6, the redundancy generator 132 comprises a data memory 132a and an exclusive OR (XOR) operator 132b. The data memory 132a has a storage capacity for storing data of one sector and stores calculation result data calculated by the XOR operator 132b which will be described later. The XOR operator 132b performs an XOR operation of normal sector data of one sector input from the buffer controller 130 and the calculation result data stored in the data memory 132a at each bit position. The XOR operator 132b stores new calculation result data in the data memory 132a.

The identification code module 133 stores the identification code to be set in the identification area of the normal sector and is, for example, a register. Further, the identification code is stored in the identification code module 133 by the MPU 160, which will be described later. The operation of the MPU 160 will be described later.

The format controller 140 performs an error check on data transmitted between the upper apparatus 10 and the magnetic disc device 100. For example, the format controller 140 receives data from the read channel 150, performs an error correction on the data according to a need and outputs error-corrected data to the buffer controller 130 at the time of data reading.

For example, the format controller 140 receives data from the upper apparatus 10 through the host I/F controller 120, adds the identification code or the error correcting code (ECC information) to the data, and outputs the data to the read channel 150 at the time of data writing. At this time, the format controller 140 acquires the identification code from the identification code module 133 and adds the acquired identification code to the data.

The read channel 150 analog-to-digital (AD)-converts or modulates and demodulates data transmitted between the upper apparatus 10 and the magnetic disc device 100. For example, the read channel 150 amplifies a data signal output from the head IC 115 and executes predetermined processing such as AD conversion and demodulation at the time of data reading. Further, for example, the read channel 150 code-modulates data input from the format controller 140 at the time of data writing.

The MPU 160 performs the main control of the magnetic disc device 100 by a firmware program. That is, the MPU 160 decodes a command from the upper apparatus 10 to control the respective processors and controls data reading/writing from/to the magnetic storage medium 111 in general. The MPU 160 may be a micro controller unit (MCU) or a central processing unit (CPU).

In the following, the operation of the MPU 160 of the embodiment will be described in detail. When data has been received from the upper apparatus 10, the MPU 160 determines whether the data is to be written to part of normal sectors belonging to a predetermined data section.

When the data is to be written to part of normal sectors, the MPU 160 stores the identification code (“N” in the example illustrated in FIGS. 1A and 1B) indicating that the redundant sector data is invalid in the identification code module 133.

Meanwhile, when data is to be written to all the normal sectors belonging to a predetermined data section, the MPU 160 stores the identification code (“M” in the example illustrated in FIGS. 1A and 1B) indicating that the redundant sector data is valid in the identification code module 133.

The memory 170 and the non-volatile memory 180 store a predetermined control program (a firmware program) which operates in the MPU 160 or various control data. The servo controller 190 drives the VCM 113 and the SPM 114 according to an instruction input from the MPU 160.

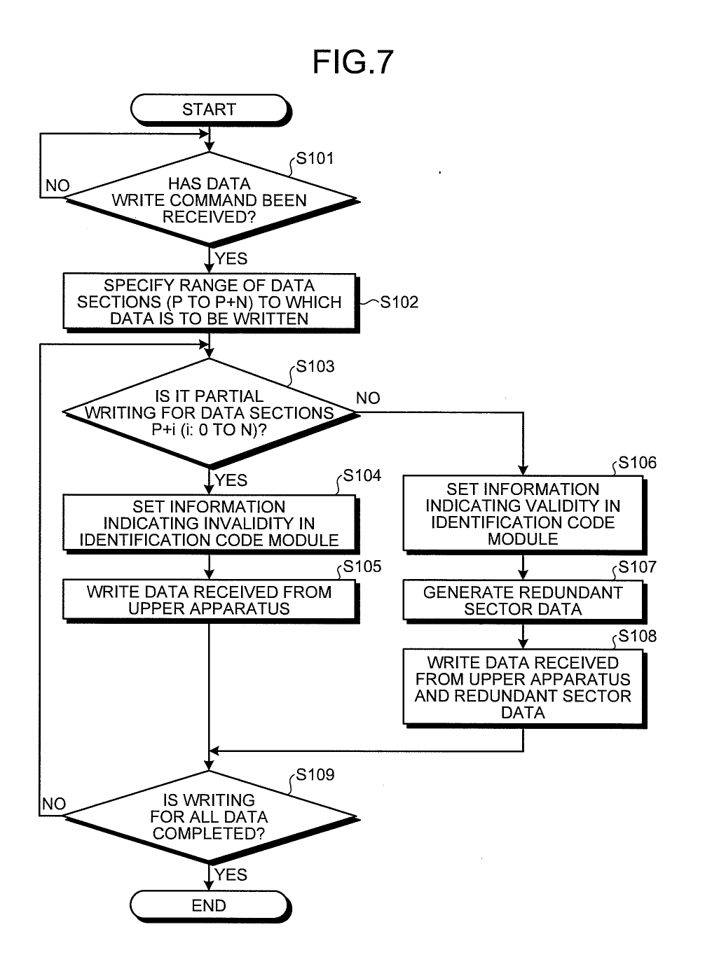

Next, a data write process performed by the magnetic disc device 100 of the embodiment will be described. FIG. 7 is a flowchart of the data write process performed by the magnetic disc device 100 according to the embodiment.

As illustrated in FIG. 7, when a data write command has been received from the upper apparatus 10 (Yes at S101), the MPU 160 of the magnetic disc device 100 specifies a range of data sections to which data is to be written (S102). It is assumed herein that the range of the data sections to which data is to be written is data sections P to P+N. It is also assumed that the magnetic disc device 100 performs data write operation in an order of the data sections P, P+1, . . . , P+N.

Subsequently, the MPU 160 determines whether data to be written to the data section P+i (i: a value from 0 to N) is to be written to some normal sectors belonging to the data section P+i.

When it is determined that the data is to be written to some normal sectors belonging to the data section P+i (Yes at S103), the MPU 160 sets the identification code indicating that the redundant sector data is invalid in the identification code module 133 (S104).

Data input from the upper apparatus 10 is stored in the buffer memory 131 via the host I/F controller 120 and the buffer controller 130. Subsequently, when timing for write operation comes, the data stored in the buffer memory 131 is output to the format controller 140 via the buffer controller 130.

The format controller 140 adds the SB or the error correcting code to the input data. At this time, the format controller 140 sets the identification code stored in the identification code module 133 in the identification area of the input data. The format controller 140 outputs the data to which the identification code has been added to the read channel 150.

The head 112 receives the data output from the format controller 140 via the read channel 150 and the head IC 115 and writes the received data to the magnetic storage medium 111 (S105).

Meanwhile, when it is determined that data is to be written to all the normal sectors belonging to the data section P+i (No at S103), the MPU 160 sets the identification code indicating that the redundant sector data is valid in the identification code module 133 (S106).

Data input from the upper apparatus 10 is stored in the buffer memory 131 via the host I/F controller 120 and the buffer controller 130 and is output to the format controller 140 via the buffer controller 130 when timing for write operation comes.

Further, data stored in the buffer memory 131 is output to the redundancy generator 132 via the buffer controller 130. The redundancy generator 132 generates redundant sector data by using the input data (S107). The MPU 160 controls the format controller 140 so that the redundant sector data output from the redundancy generator 132 can be written following the data input from the upper apparatus 10.

The format controller 140 adds the SB or the error correcting code to the data input from the upper apparatus 10 and sets the identification code stored in the identification code module 133. The format controller 140 outputs the data with the identification code added thereto to the read channel 150. Thereafter, the format controller 140 outputs the redundant sector data output from the redundancy generator 132 to the read channel 150.

The head 112 receives the data and the redundant sector data which are output from the format controller 140 via the read channel 150 and the head IC 115 and writes the received data and the received redundant sector data to the magnetic storage medium 111 (S108).

When writing of all data from the upper apparatus 10 in the magnetic storage medium 111 is completed (Yes at S109), the process ends. That is, when data write operation for all data sections specified at S102 has been performed, the process ends. However, when writing of all data from the upper apparatus 10 in the magnetic storage medium 111 is not completed (No at S109), the magnetic disc device 100 performs the above process (S103 to S108) again.

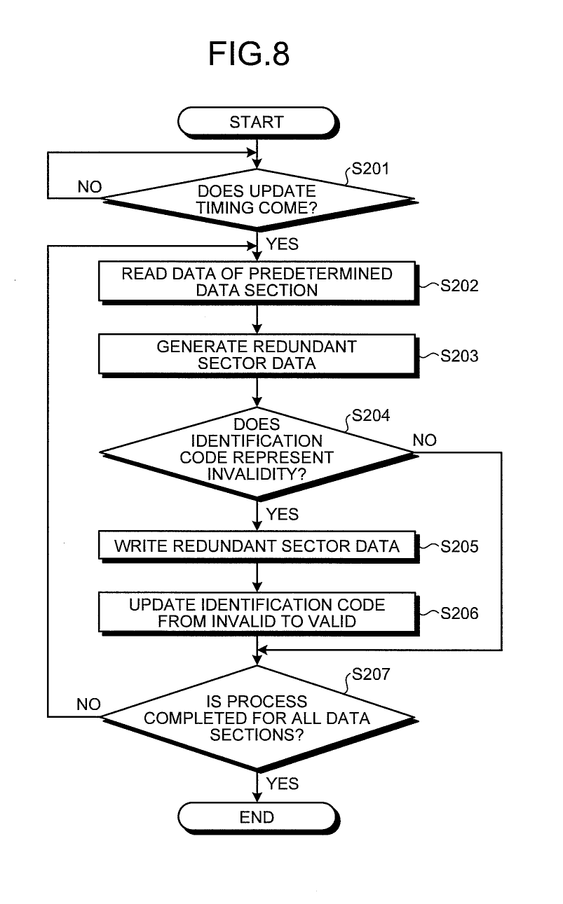

Next, a redundant sector data update process performed by the magnetic disc device 100 according to the embodiment will be described. FIG. 8 is a flowchart of the redundant sector data update process performed by the magnetic disc device 100 according to the embodiment.

As illustrated in FIG. 8, when timing for updating the redundant sector data comes (Yes at S201), the MPU 160 of the magnetic disc device 100 controls to read data of each data section from the magnetic storage medium 111. Here, “timing for updating the redundant sector data” represents, for example, timing in which access to the magnetic storage medium 111 is not performed as described above.

When reading control is performed by the MPU 160, the head 112 reads data of a predetermined data section from the magnetic storage medium 111 (S202). The data read by the head 112 is output to the format controller 140 via the head IC 115 and the read channel 150.

The format controller 140 stores the identification code stored in the identification area among the input data in the identification code module 133. The format controller 140 outputs the input data to the buffer controller 130. The buffer controller 130 stores the input data in the buffer memory 131 and outputs the input data to the redundancy generator 132. The redundancy generator 132 generates redundant sector data by using the data input from the buffer controller 130 (S203).

Subsequently, the MPU 160 determines whether the identification code (“N” in the example of FIGS. 1A and 1B) indicating that the redundant sector data is invalid is stored in the identification code module 133. When it is determined that the identification code indicating that the redundant sector data is invalid is stored in the identification code module 133 (Yes at S204), the MPU 160 controls to write the redundant sector data generated by the redundancy generator 132 to the magnetic storage medium 111.

When control for writing the redundant sector data is performed by the MPU 160, the head 112 receives the redundant sector data output from the redundancy generator 132 via the format controller 140, the read channel 150, and the head IC 115 and writes the redundant sector data to the magnetic storage medium 111 (S205).

Subsequently, the MPU 160 controls to update the identification code of the normal sector belonging to the data section in which data has been read with information indicating that the redundant sector data is valid. When control for updating the identification code is performed by the MPU 160, the head 112 updates information stored as the identification code with information indicating that the redundant sector data is valid (S206).

When data reading is completed for all data sections in which data is stored in the magnetic storage medium 111 (Yes at S207), the process ends. On the other hand, when data reading is not completed for all data sections in which data is stored in the magnetic storage medium 111 (No at S207), the magnetic disc device 100 performs the above process (S202 to 5206) again.

As described above, according to the embodiment, the magnetic disc device 100 stores the identification code indicating whether the redundant sector data is valid in the magnetic storage medium 111. Therefore, the magnetic disc device 100 can determine the validity of the redundant sector data without using the memory resource.

While a specific embodiment has been described, other embodiments or modifications are also possible. In the following, such modifications will be described.

In the above embodiment, while an identification area is described as being set for each normal sector, the magnetic storage medium 111 need not necessarily have an identification area for each normal sector. For example, the magnetic storage medium 111 may have an identification area only in a specific normal sector among a plurality of normal sectors belonging to a data section. In this case, the magnetic disc device 100 determines whether redundant sector data is valid based on identification data stored in the specific normal sector.

Further, for example, the magnetic storage medium 111 may have an identification area in a redundant sector. In this case, the magnetic disc device 100 determines whether redundant sector data is valid based on identification data stored in the redundant sector. In this manner, by setting an identification area in a specific normal sector or only redundant sector, the capacity of the magnetic storage medium 111 for storing user data can be increased.

All or arbitrary part of the process functions performed by the magnetic disc device 100 can be implemented by a CPU and a computer program analyzed and executed by that CPU, or can be implemented as hardware with a wired logic.

The constituent elements described above are functionally conceptual, and need not be physically configured as illustrated. In other words, the specific mode of dispersion and integration of the constituent elements is not limited to the ones illustrated in the drawings, and the constituent elements, as a whole or in part, can be divided or integrated either functionally or physically in arbitrary units based on various types of loads or use conditions.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A storage device comprising:
a storage medium comprising a plurality of normal sectors configured to store data and a redundant sector configured to store redundant sector data for restoring data in the normal sectors; and
a controller configured to store invalid information in a normal sector when data is to be written to the normal sector in a data section of a combination of the normal sectors and the redundant sector corresponding to the normal sectors, the invalid information indicating that the redundant sector data in the redundant sector in the data section is invalid.

2. The storage device of claim 1, wherein the controller is configured to generate new redundant sector data based on data in the normal sectors in the data section, to store the new redundant sector data in the redundant sector in the data section, and to store valid information indicating that the new redundant sector data is valid in the normal sector to which data is to be written, when data has been written to the normal sectors in the data section.

3. The storage device of claim 1, wherein the controller comprises:
a determining module configured to determine whether there is a normal sector configured to store the invalid information when data is to be read from the storage medium; and
an updating module configured to generate new redundant sector data for the data section which comprises a normal sector when the determining module determines that the normal sector comprises the invalid information, to update the redundant sector data in the redundant sector in the data section with the new redundant sector data, and to store the valid information in the normal sector in the data section which comprises the redundant sector.

4. A storage device control method of controlling a storage device configured to access a storage medium, the storage device control method comprising:
controlling the storage device to store invalid information in a normal sector when data is to be written to the normal sector in a data section of a combination of the normal sectors and the redundant sector corresponding to the normal sectors, the invalid information indicating that the redundant sector data in the redundant sector in the data section is invalid.

5. The storage device control method of claim 4, further comprising:
generating new redundant sector data based on data in the normal sectors in the data section;
storing the new redundant sector data in the redundant sector in the data section; and
storing valid information indicating that the new redundant sector data is valid in the normal sector to which data is to be written,
when data has been written to all the normal sectors in the data section.

6. The storage device control method of claim 4, further comprising:
determining whether there is a normal sector comprising the invalid information when data is to be read from the storage medium;
generating new redundant sector data for the data section comprising a normal sector, when it is determined that the normal sector comprises the invalid information at the determining,
updating the redundant sector data in the redundant sector in the data section with the new redundant sector data; and
storing the valid information in the normal sector in the data section which comprises the redundant sector.
